(19) United States
(12) Patent Application Publication
(10) Pub. No.: US 2007/0092068 A1
(43) Pub. Date: Apr. 26, 2007

(54) Method and device for moving a tomography apparatus gantry

(76) Inventor: Laurentius Albert, Hetzles (DE)

Correspondence Address: SCHIFF HARDIN, LLP;PATENT DEPARTMENT, 6600 SEARS TOWER, CHICAGO, IL, 60606-6473, US

(21) Appl. No.: 11/584,033

(22) Filed: Oct. 20, 2006

(30) Foreign Application Priority Data
Oct. 20, 2005 (DE) 10 2005 050 634.8

(51) Int. Cl. H05G 1/02

(52) U.S. Cl. 378/198

(57) ABSTRACT

In a method and device for a moving gantry of a tomography apparatus for horizontal introduction of the gantry into a building or a room, a frame accommodates the gantry and two lifting devices which can respectively be connected with the frame via supports such that a pivot axis extending through the supports around which pivot axis the frame with the gantry can be pivoted, proceeds substantially through the center of gravity of the frame provided with the gantry.

### BACKGROUND OF THE INVENTION

1. Field of the Invention

The present invention concerns a device for moving a gantry of a tomography apparatus which serves to bring the gantry into a building or into a room in which the tomography apparatus should be operated. The invention also concerns a method for moving a gantry for that purpose.

2. Description of the Prior Art

Tomography apparatuses, which include x-ray computed tomography apparatuses, PET apparatuses, SPECT apparatuses and combination apparatuses of such modalities, have a gantry as well as a patient positioning device that can be connected with the gantry. The gantry, which can be separated from the patient positioning device (such as for the transport of the tomography apparatus from its manufacturing location to its installation or operation location in a clinic or a medical practice), frequently exhibits dimensions such that the gantry cannot be brought into the building or the room (which represents the installation site of the tomography apparatus) in conventional ways. Often there are halls leading to the installation site, or stairways or doors leading into the installation room of the tomography apparatus, that are too narrow or too small to allow the gantry to be brought to its operation location in a conventional manner. When the operation location of the gantry is located in an upper level of a building, aside from the dimensions of the gantry the available elevators often are not suited to transport the mass of the gantry, which can amount to a metric ton or more. Given disadvantageous spatial conditions, building facades or external walls have to be opened in part in order to be able to bring the gantry to its operation location. This incurs not-insignificant costs and, under the circumstances, also influences the purchase decision of a customer. Moreover, it must always be assured that the highly-sensitive measurement system contained in the gantry is not damaged.

### SUMMARY OF THE INVENTION

An object of the present invention is to provide a device of the aforementioned type as well as a method using such a device that simplify the introduction of a gantry of a tomography apparatus into a building or into an operating room.

According to the invention this object is achieved by a device for moving a gantry of a tomography apparatus for horizontal introduction of the gantry into a building or a room, having a frame for accommodation of the gantry and two lifting devices are each connectable to the frame via a support such that a pivot axis extending through the supports (around which pivot axis the frame with the gantry can be pivoted) proceeds substantially through the center of gravity of the frame provided with the gantry. According to the invention the device introduces the gantry into a building or into a room not in the conventional manner (in a vertical position), which corresponds to its operating position, but rather in horizontal position. Since the gantry is substantially higher than it is long, after a pivoting of the gantry, the horizontal openings that are already present in a building or in a room are frequently sufficient to allow the gantry to be introduced into the building or the room in this form. Depending on the dimensions of the gantry, room openings of two meters width and one meter height can be sufficient in order to be able to introduce the gantry into the building or the room. Existing opening for windows often exhibit such dimensions, such that no larger structural alterations to the building or the room must be made to introduce the gantry into a building or into a room, so the costs for the introduction of the gantry into the building or the room can be kept low. Since the gantry exhibits a relatively large mass and accordingly is difficult to transport (in particular to rotate and pivot) particularly in narrow spatial conditions, the inventive device is designed such that the frame in which the gantry is accommodated can be connected with lifting devices via two supports. The device is designed such that, when the gantry is accommodated by the frame and is raised by the lifting devices, the pivot axis extending through both supports (around which pivot axis the frame with the gantry can pivot by at least 90°) proceeds substantially through the center of gravity of the frame provided with the gantry. Because the center of gravity is substantially on the pivot axis, an unintended, inertial pivoting movement of the frame occurs is prevented when the frame provided with the gantry is raised with the lifting devices. The safety of the transport personnel is thus insured damage to the gantry is avoided. Furthermore, it is achieved that the gantry can be brought manually from its vertical position into the horizontal position without further (for example motorized) auxiliary means which would entail additional weight. If the gantry is brought into the horizontal position, it can be brought into the room with a crane basket via a window of the installation room, for example. For this purpose the lifting devices can be demounted for weight and space savings. After the gantry has been brought into the room, it can be mounted again (if necessary) after connection to the lifting devices, and be brought into operating position.

In an embodiment of the invention the frame has at least two frame parts that can be connected with one another and separated again. According to a further variant of the invention, the two frame parts of the frame can be bolted with one another, one frame part forming a guide that is inserted into a corresponding counterpart of the other frame part such that the frame can be properly assembled. The (normally cuboid) frame is designed as a type of cage for the gantry, meaning that the two frame parts have metallic bars that exhibit a hollow profile for weight saving. The execution of the frame in two parts enables the frame to be arranged around the gantry in a simple manner. To secure the gantry it is bolted with the frame at points provided for this purpose.

When the gantry exhibits a stationary part and a rotatable part, as is the case, for example, in x-ray computed tomography apparatuses of the third generation, in a variant of the invention the frame has an arresting device in order to secure the rotatable part of the gantry against an unintended rotation during the pivoting of the gantry from the vertical into the horizontal, and overall in order to secure the rotatable part for transport. The arresting device is normally at least one additional bar of the frame on which the rotatable part of the gantry can be fixed by means of a bolt passing through the rotor of the rotatable part of the gantry.

According to another embodiment of the invention, the frame has fastening surfaces on two opposite sides for flanges that can respectively interact with a support shell of a lifting device. The flanges are normally attached to the fastening surfaces with bolts and thus can be connected with the frame in a simple manner as needed, or be removed again from the frame should a hindrance (for example upon introduction through a window front) temporarily result due to the flanges. Each flange is executed such that it can interact with support shells arranged on a lifting device, such that after a raising of the frame, the frame provided with the gantry can be brought from the vertical into the horizontal by pivoting around the pivot axis established through the support shells.

According to a variant of the invention, at least one arresting bolt or securing bolt is additionally provided at the device in order to be able to avoid an unintended pivoting of the frame relative to the lifting devices in every case. For this purpose, for example, the support shells, as well as each part of the flange that interacts with the support shell, exhibit an aperture or bore into which the arresting bolts can be introduced. The frame provided with the gantry also can be fixed with arresting bolts both in the perpendicular position and in the horizontal position.

According to a preferred embodiment, the lifting devices of the device are fashioned as lift trucks for the gantry. In this manner the gantry can be moved into the vertical position and into the horizontal position in an advantageous manner before an introduction into a building or into a room and after the introduction into the building and the room.

In a further embodiment of the invention, each of the lifting devices has a lifting spindle (which can be operated manually) such that the frame can be raised or lowered by the lifting spindles of the frame. Should the weight requirement allow it, motors (advantageously electromotors) can also be provided at the lifting devices in order to operate the spindles.

According to a variant of the invention the device is provided for a gantry of an x-ray computed tomography apparatus, a PET apparatus and/or a SPECT apparatus.

### DESCRIPTION OF THE DRAWINGS

FIG. 1 shows a device in accordance with the invention provided with a gantry of an x-ray computed tomography apparatus for horizontal introduction of the gantry.

FIGS. 2, 3 show details of an alternative support of the frame.

FIG. 4 shows the device from FIG. 1 with the frame raised.

FIG. 5 is a side view of the device of FIG. 4.

FIG. 6 shows the pivoting of the frame accommodating the gantry by 90°.

### DESCRIPTION OF THE PREFERRED EMBODIMENTS

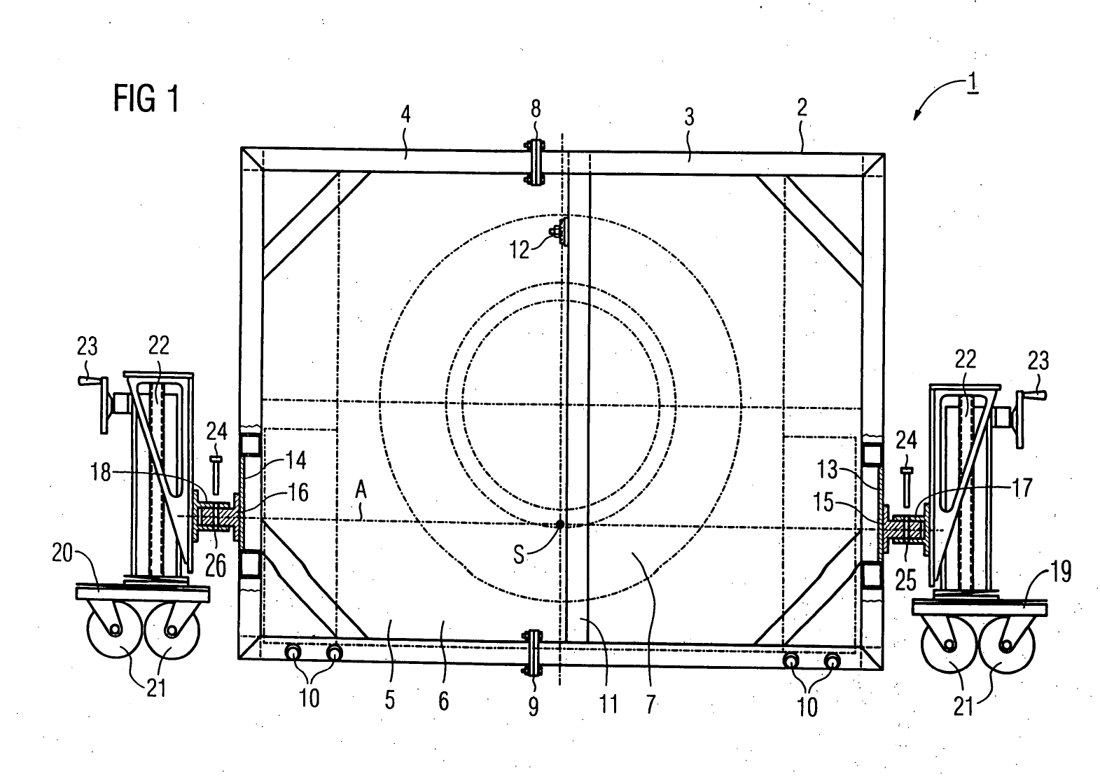

FIG. 1 illustrates a device 1 for moving a gantry of a tomography apparatus for horizontal introduction of the gantry into a building or into a room. In the exemplary embodiment the device 1 has a cuboid frame 2 that is composed of two partial frames 3 and 4. The frame 2 effectively forms a type of cage for a gantry 5 (indicated in FIG. 1 with dashed lines) which, in the case of the exemplary embodiment, is a gantry of an x-ray computed tomography apparatus, the patient positioning device of which is not shown. The gantry 5 has a part 6 that is stationary during operation of the x-ray computed tomography apparatus and a rotatable part 7. The rotatable part has (in a known manner not shown in the figures) a rotor as well as an x-ray source and an x-ray detector that are arranged opposite one another on the rotor. The measurement system of the gantry 5, which measurement system includes the x-ray source and the x-ray detector, is highly sensitive and therefore must be carefully handled during the transport of the gantry 5 from the production site to the operation site. The gantry 5 exhibits a mass of approximately one metric ton as well as height, length and width dimensions that sometimes do not allow the gantry 5 to be brought as desired into an upright position in an operating room provided for the gantry 5 in a clinic or a medical practice, since the accesses (such as the doors) to the operation room either exhibit dimensions that are too small or corridors, halls, stairwells or elevators leading to the operation room that are not suitable for the transport of the gantry 5 with regard to the mass and/or the dimensions of the gantry. For this reason, in accordance with the invention the gantry 5 is brought into a horizontal position by the device 1 shown in FIG. 1 in order to be able to bring the gantry 5 into a building or into an operating room 5 in this manner, for example via a window opening.

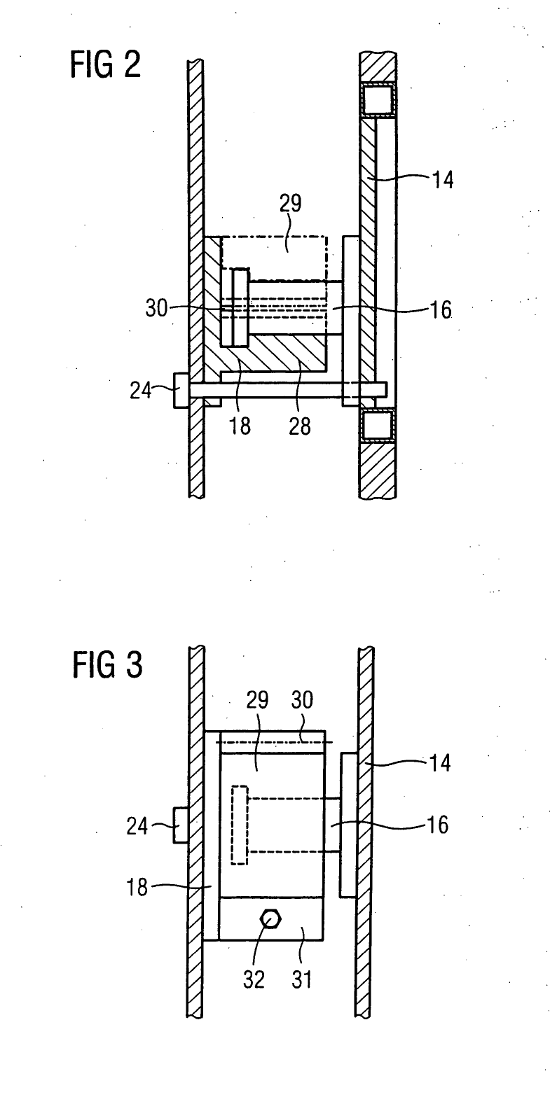

In order to be able proceed in such a manner, the outer covering housing elements of the gantry 5 (which are normally plastic and/or plates) are removed (in a manner not shown in the figures) and the gantry 5 is brought into the cage-like frame 2 as shown in FIGS. 1 and 2. In order to accomplish this the frame 2 is, as already mentioned, executed in two parts such that both frame parts 3 and 4 can be brought together from one side of the gantry 5 in order to ultimately be bolted with one another via flanges 8 and 9. The frame parts 3 and 4 have internally hollow metallic .bars that, in the exemplary embodiment, are welded with one another at both frame parts 3, 4. For attachment of the frame 2 the gantry 5 is normally placed (in a manner not shown in the figures) on palettes, such that sufficient free space is present at the gantry to arrange the frame parts 3 and 4 and connect them with one another. For this purpose, one of the frame parts normally has a guide that can be inserted into a matching counterpart of the other frame part in order to ensure that the frame parts 3 and 4 are connected with. one another with positive fit. As can be seen from FIG. 1, the gantry 5 is bolted with the frame 2 by bolts 10 at individual points for security. Moreover, in the exemplary embodiment shown in FIG. 1 the frame part 3 has a crossbar 11 on which the rotatable part 7 of the gantry 5 (more precisely the rotor of the rotatable part 7) can be secured against rotation during the transport either directly with a bolt or by a further bar (not shown) in order to not endanger the transport personnel and on the other hand to avoid damaging the highly-sensitive measurement system arranged on the rotor. In FIG. 1 it can be seen that the rotatable part 7 of the gantry 5 is secured against the crossbar 11 with a bolt 12, for which purpose the rotor of the rotatable part of the gantry 7 has a corresponding bore.

Fastening surfaces 13, 14 to which flanges 15 and 16 can be screwed are present at prepared locations on both sides of the frame 2. The flanges 15 and 16 have bolt-like elements. The bolt-like elements of the flanges 15, 16, as shown in FIG. 1, can be respectively brought into engagement with a support shell 17, 18 of a lift truck 19, 20. Each of the lift trucks 19 and 20 has four steering rollers 21 as well as a lifting spindle 22 that is connected with the support shell of the lift truck. In the exemplary embodiment, the lifting spindles 22 are operated manually and therefore have manually operable rotating hand wheels. This embodiment of the lift trucks 19 and 20 is preferred with regard to a weight savings. However, there also exists the possibility to operate the lifting spindles 22 via electromotors (not shown).

When the flanges 15, 16 are brought into engagement with the support shells 17, 18 by the approach of the lift trucks 19 and 20 toward the frame 2, on both sides of the device 1 respective arresting bolts 24 are inserted into openings 25, 26 (provided for this) of the bolt-shaped elements of the flanges 15, 16 and of the support shells 17, 18. This avoids an unintended slippage of the bolt-like elements of the flanges 15, 16 from the support shells 17, 18 as well as to avoid an unintended pivoting of the frame 2 relative to the lift trucks 19, 20 around the pivot axis A established through the flanges 15, 16 and the support shells 17, 18 when the frame 2 is raised. With the lifting spindles 22 of the lift trucks 19, 20, the frame 2 provided with the gantry 5 is subsequently raised until a pivoting of the frame 2 provided with the gantry 5 around the pivot axis A is possible. The device 1 is designed such that the pivot point S of the frame 2 provided with the gantry 5 lies substantially on the pivot axis A. In this manner it is ensured that the frame 2 provided with the gantry 5 does not pivot uncontrolled around the pivot axis A. Moreover, in view of the large mass of the gantry 5 the frame 2 provided with the gantry 5 can be manually pivoted 90° around the pivot axis A in an advantageous manner with low force application. The pivoting of the frame 2 provided with the gantry 2 ensues after the removal of the arresting bolts which, if applicable, can be reused to arrest the frame 2 in the horizontal position, for which purpose the support shells 17, 18 exhibits a second bore. Moreover, only one arresting bolt can be sufficient for arresting.

As an alternative to the use of the flanges 15, 16 and support shells 17, 18 shown in FIG. 1, the flanges and support shells can be executed as exemplarily shown in FIGS. 2 and 3 using the flange 16 and the support shell 18. According to this the flange 16 has a T-shaped, bolt-like element. In this embodiment the support shell 18 is designed in two parts and comprises both a lower support shell part 28 and an upper support shell part 29 adapted to the T-shaped, bolt-like element. The support shell parts 28, 29 are connected with one another via an articulation 30 and each has an essentially planar shoulder 31. After closing of the support shell parts 28 and 29 by folding down the upper support shell part 29 on the articulation 30, the shoulders 31 can be moved toward one another by means of a clamping screw 32. If, due to the approach of the lift truck 20 toward the frame 2, the T-shaped, bolt-like element of the flange 16 has been brought into engagement with the support shell part 28, the support shell 18 is closed by folding down the upper support shell part 29. The screw 32 thus not only fixes the support shell parts 28, 29 but also (depending on the tightness of the screw 32) enables a braking effect to be achieved for the pivot process. In this embodiment an arresting bolt 24 is additionally provided which, as can be seen from FIG. 2, proceeds through the fastening element of the flange 16 and the support shell 18. For this purpose, both fastening elements exhibit a bore. The fastening element of the flange 16 additionally exhibits a second bore in order to likewise be able to arrest the frame 2 pivoted by 900 with the arresting bolt 24.

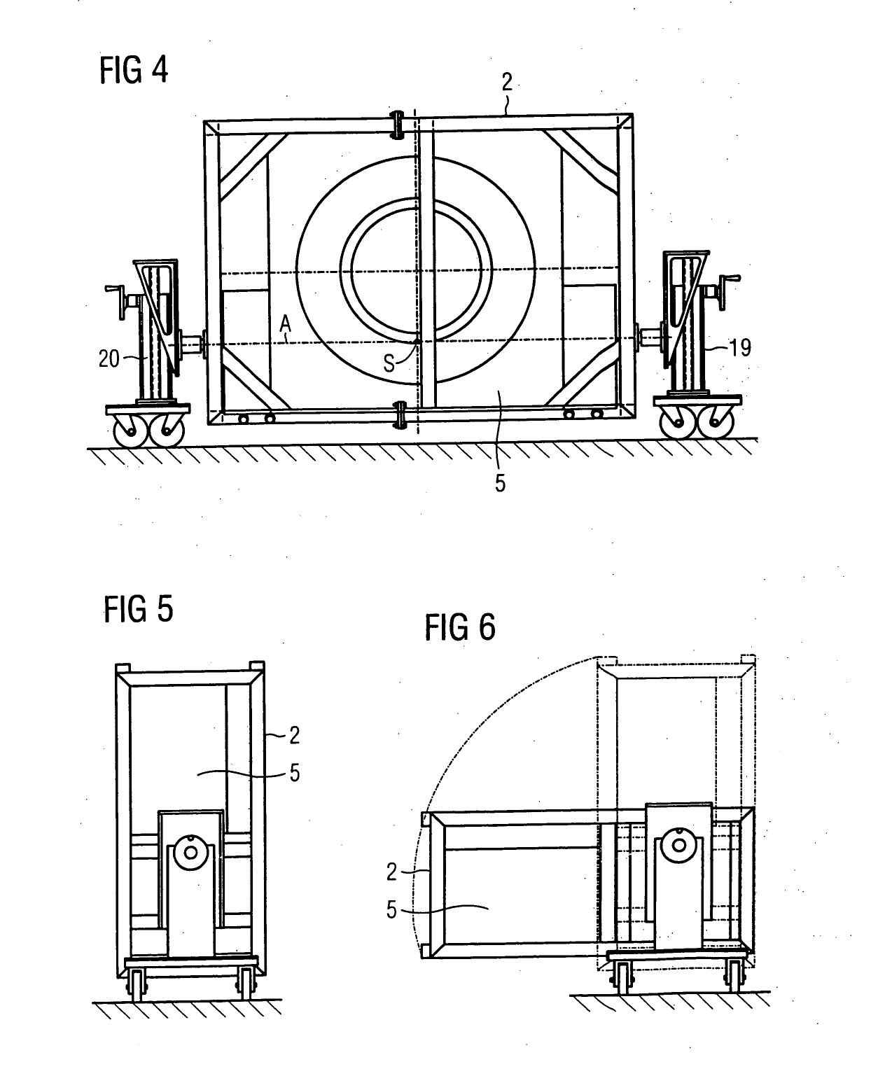

FIGS. 4 through 6 illustrate the design of the device 1 as well as the operating manner of the device 1. From FIG. 4 it can be seen that the frame 2 of the device 1 has been raised with the lift trucks 19, 20 such that the frame 2 provided with the gantry 5 can be pivoted by at least 90° on the pivot axis A. In this regard FIG. 5 shows a side view of the device 1 from FIG. 4. The pivot process of the frame 2 provided with the gantry 5 is illustrated in FIG. 6. In the shown horizontal alignment of the gantry 5, given disadvantageous structural conditions this can (as already explained) be introduced into a building or into a room in an advantageous manner (for example through a window) without having to undertake large structural modifications to the building itself.

In summary, in the process, for the introduction of the gantry 5 into a building or a room of a building, the casing parts of the gantry 5 are initially removed, the gantry 5 is fixed into the frame 2 of the device 1, the frame 2 provided with the gantry 2 is raised with the lift trucks 19, 20 and pivoted by 90° such that the gantry 5 is located in the horizontal, the gantry is brought to a window of a building (for example with a crane basket) and inserted into the room through the window. For this purpose the lift trucks 19, 20 as well as the flanges 15 and 16 can be removed from the frame 2 after the frame 2 With the gantry 5 has been brought into the horizontal, such that only the frame 2 is brought (for example with a crane basket) to the window of the respective building. If the frame 2 with the gantry 5 has been brought through the window into the building and, for example, has been placed on palettes, the flanges 15, 16 can again be fastened onto the frame 2 and the lift trucks 19, 20 can be moved up to the fame 2 in order to further move the gantry 5 wither with the lift trucks 19, 20 or to bring the gantry 5 into an upright position again in order to install it directly in the respective room or, if applicable, to bring it into the desired operation room insofar as the spatial conditions allow.

The invention was described in the preceding based on the example of a gantry of an x-ray computed tomography apparatus, but the this inventive device is also suitable for gantries of PET apparatuses or SPECT apparatuses.

Since gantries of different tomography apparatuses can be transported with the device, the center of gravity of the frame 2 provided with the respective gantry does not necessarily have to lie on the pivot axis. The device thus can also be used when the center of gravity of the frame provided with the gantry lies slightly outside of the pivot axis.

The design of the frame 2 described in the preceding is only exemplary. The frame can be designed differently.

The lifting devices also do not necessarily have to be executed as lift trucks, in particular when the frame should not be moved with the, lifting devices.

Moreover, the support shells can be arranged on the frame and the bolt-like elements (respectively interacting with one support shell) can respectively be arranged on a lifting device.

Although modifications and changes may -be suggested by those skilled in the art, it is the intention of the inventor to embody within the patent warranted hereon all changes and modifications as reasonably and properly come within the scope of his contribution to the art.

I claim as my invention:

1. A device for moving a gantry of a tomography apparatus, comprising:
a frame adapted to receive and hold a gantry of a tomography apparatus, said frame having two opposite sides, and a combination of the gantry in the frame having a center of gravity;
two mobile lifting devices; and
two supports rigidly attached to said frame and releasably connecting the respective lifting devices at said two opposite sides of said frame, each of said supports having a pivot axis proceeding therethrough, the respective pivot axes being aligned and proceeding substantially through said center of gravity and allowing said frame with the gantry therein to be pivoted substantially around said center of gravity to permit said frame with said gantry therein to be selectively moved to a horizontal orientation.

2. A device as claimed in claim 1 wherein said frame comprises at least two frame parts that are separately connected with each other to form said frame.

3. A device as claimed in claim 2 wherein said frame parts are bolted together to form said frame.

4. A device as claimed in claim 1 wherein said gantry comprises a stationary part and a rotatable part, said device comprising an arresting device mounted at said frame adapted to interact with said rotatable part to secure said rotatable part from rotating.

5. A device as claimed in claim 1 wherein each of said supports comprises a flange fastened at a fastening surface to one of said two opposite sides of the said frame, and a support shell attached to one of said two lifting devices, said flange and said support shell being rotatable relative to each other.

6. A device as claimed in claim 5 wherein each of said support comprises an arresting bolt selectively insertable through said flange and said support shell, to temporarily prevent relative rotation between said flange and said support shell.

7. A device as claimed in claim 1 wherein said two lifting devices are to lift trucks.

8. A device as claimed in claim 1 wherein each of said two lifting devices comprises a manually operable lifting spindle.

9. A device as claimed in claim 1 wherein each of said two lifting devices comprises a motorized lifting spindle.

10. A device as claimed in claim 1 wherein said frame is adapted to receive and fold a gantry of a tomography apparatus selected from the group consisting of an x-ray computed tomography apparatus gantry, a PET apparatus gantry and a SPECT apparatus gantry.

11. A method for moving a gantry of a tomography apparatus for horizontal introduction of the gantry into a room or building, comprising the steps of:
receiving and holding a gantry of a tomography apparatus in a frame having two opposite sides, a combination of the gantry in the frame having a center of gravity and;
rigidly attaching two supports to said frame and releasably connecting two lifting devices respectively at said two opposite sides of said frame, each of said supports having a pivot axis proceeding therethrough, aligning the respective pivot axes so as to proceed substantially through said center of gravity, and allowing said frame with the gantry therein to be pivoted substantially around said center of gravity to permit said frame with said gantry therein to be selectively moved to a horizontal orientation.
